(19) United States
(12) Patent Application Publication
(10) Pub. No.: US 2024/0173104 A1
(43) Pub. Date: May 30, 2024

(54) MICRO-MAGNETIC INTEGRATED ORTHODONTIC BRACKET, FLEXIBLE MAGNETIC PATCH AND PREPARATION METHOD THEREOF

(71) Applicant: Union Hospital, Tongji Medical College, Huazhong University of Science and Technology, Wuhan (CN)

(72) Inventors: LiLi Chen, Wuhan (CN); JiWei Sun, Wuhan (CN); QingMing Tang, Wuhan (CN); JunYuan Zhang, Wuhan (CN)

(21) Appl. No.: 18/112,547

(22) Filed: Feb. 22, 2023

Related U.S. Application Data
(63) Continuation of application No. PCT/CN2023/071436, filed on Jan. 9, 2023.

(30) Foreign Application Priority Data
Nov. 29, 2022 (CN) 2022115088043

(51) Int. Cl. A61C 7/14

(52) U.S. Cl. CPC A61C 7/146

(57) ABSTRACT

A micro-magnetic integrated orthodontic bracket, a flexible magnetic patch and a preparation method thereof are provided. The micro-magnetic integrated orthodontic bracket includes a base body and an arch wire groove disposed on the base body. The arch wire groove is used for threading an arch wire. Under normal orthodontic treatment, the micro-magnetic integrated orthodontic bracket is normally disposed on a buccal side of a tooth, and its front side is normally arranged with the arch wire for force exertion to carry out the orthodontic treatment. And the micro-magnetic integrated orthodontic bracket serves as a carrier to bear the orthodontic treatment force generated by the arch wire.

### CROSS-REFERENCE TO RELATED APPLICATION

This application claims priority to Chinese patent application No. 202211508804.3 filed on Nov. 29, 2022 and entitled “Micro-Magnetic Integrated Orthodontic Bracket, Flexible Magnetic Patch and Preparation Method thereof”, the entire contents of which are incorporated herein by reference.

### TECHNICAL FIELD

The disclosure relates to the field of oral orthodontic treatment technology, and particularly to a micro-magnetic integrated orthodontic bracket, a flexible magnetic patch and a preparation method thereof.

### BACKGROUND

Oral and maxillofacial deformities not only affect the facial aesthetics, but also may further cause oral diseases, and in serious cases may cause psychological disorders. Therefore, the treatment for the oral and maxillofacial deformities is significantly urgent for the society. At present, orthodontic treatment is the most important method for the prevention and treatment of the oral and maxillofacial deformities. The duration of orthodontic treatment cycle is affected by the patients and treatment-related factors, such as the severity of oral and maxillofacial deformities, the compliance of patients and the design of treatment plan. Generally, a comprehensive course of the orthodontic treatment is 12 months to 36 months. A long treatment process will increase the risk of complications such as enamel demineralization, dental caries, root resorption, bone cracking, and bone fenestration, seriously affecting the quality of life of the patients and increasing the cost of treatment, thereby to result in reduced patient compliance. Therefore, how to accelerate tooth movement more safely and effectively and shorten the orthodontic treatment process has become an urgent problem in the field of orthodontic technology.

However, the existing devices for accelerating tooth movement are orthodontic acceleration devices designed separately from the conventional orthodontic components and devices, which apply external field stimulation to the teeth and periodontal tissue by the patient wearing a separate accelerator device into the oral and maxillofacial system. Such the technical scheme has a series of problems, such as the need to use additional devices, the high cost of preparation and construction, the inconvenient use and operation, easy to cause oral hygiene, the poor wearing comfort of patients, and the low compliance of patients.

Moreover, the existing device for accelerating the tooth movement is based on the principle of local physical vibration stimulation, ultrasonic stimulation or near-infrared stimulation. However, the mechanical stimulation causes discomfort to patients, and near-infrared photothermal effect causes potential burning injury to oral mucosa. These problems have seriously restricted the efficacy and popularity of the existing orthodontic acceleration device in the orthodontic clinical treatment.

Micro-magnetic fields widely exist in organisms and their environments, playing an important role in tissue metabolism, reconstruction and maintenance of a steady state. Research have shown that local micro-magnetic field stimulation can accelerate the metabolic rate of bone tissue, promote the process of bone tissue remodeling, which plays an important role in fracture healing and bone defect regeneration. Therefore, applying the local micro-magnetic field to stimulate the alveolar bone tissue during the orthodontic treatment is expected to accelerate the metabolism and remolding of alveolar bone, and thus improve the rate of orthodontic tooth movement.

### SUMMARY

The disclosure provides a micro-magnetic integrated orthodontic bracket, and the problems of poor comfort, inconvenient operation, and low patient compliance of the device for accelerating tooth movement can be solved by using one or more embodiments of the disclosure.

In a first aspect of the disclosure, a micro-magnetic integrated orthodontic bracket is provided and includes: a base body configured (i.e., structured and arranged) to fix the micro-magnetic integrated orthodontic bracket on a tooth; and an accommodating cavity disposed in the base body and filled with a magnetic material.

In another aspect of the disclosure, a flexible magnetic patch is provided and includes: a sheet silicone matrix and permanent magnetic powders dispersed into the sheet silicone matrix.

In still another aspect of the disclosure, a preparation method of the flexible magnetic patch is provided and includes: preparing the permanent magnetic powders; and mixing the permanent magnetic powders with a silicone to thereby prepare the flexible magnetic patch.

In even still another aspect of the disclosure, a method for accelerating tooth movement is provided and includes: fixing the above-mentioned micro-magnetic integrated orthodontic bracket on a buccal side of a tooth; and placing the flexible magnetic patch around the accommodating cavity thereby to excite the magnetic material to generate a local micro-magnetic field that acts on periodontal tissues.

### BRIEF DESCRIPTION OF DRAWINGS

In order to more clearly illustrate technical solutions in embodiments of the disclosure, the attached drawings used in the embodiments are briefly described below. Apparently, the attached drawings in the following description are some embodiments of the disclosure, and other drawings may be obtained from them without creative effort to those skilled in the art.

FIG. 1 illustrates a schematic perspective structural view of a micro-magnetic integrated orthodontic bracket according to an embodiment of the disclosure.

FIG. 2 illustrates a schematic view of the micro-magnetic integrated orthodontic bracket shown in FIG. 1 from another viewing angle.

FIG. 3 illustrates a schematic view of the micro-magnetic integrated orthodontic bracket shown in FIG. 1 from still another viewing angle.

FIG. 4 illustrates a schematic sectional view of the micro-magnetic integrated orthodontic bracket shown in FIG. 1.

FIG. 5 illustrates a schematic view of the micro-magnetic integrated orthodontic bracket shown in FIG. 1 in use.

FIG. 6 illustrates a schematic view of a micro-magnetic integrated orthodontic bracket generating a micro-magnetic field under a stimulation of static magnetic field according to an embodiment of the disclosure.

FIG. 7 illustrates a schematic view of a flexible magnetic patch being installed on the micro-magnetic integrated orthodontic bracket in FIG. 6.

FIG. 8 illustrates a schematic view of another flexible magnetic patch being installed on the micro-magnetic integrated orthodontic bracket in FIG. 6.

### DESCRIPTION OF REFERENCE NUMERALS

100: micro-magnetic integrated orthodontic bracket; 110: base body; 111: substrate; 112: boss; 120: arch wire groove; 130: accommodating cavity; 140: protruding portion; 150: position-limiting groove; 200: flexible magnetic patch.

### DETAILED DESCRIPTION OF EMBODIMENTS

Technical solutions in embodiments of the disclosure will be clearly and completely described below in conjunction with the attached drawings used in the embodiments of the disclosure, the described embodiments are only some embodiments of the disclosure, and not all embodiments of the disclosure. Based on the described embodiments in the disclosure, all other embodiments obtained by those skilled in the art without creative effort should belong to the scope of protection of the disclosure.

It needs to be noted that all directional indications in the described embodiments of the disclosure are used only to explain relative positional relationship among components and motion of the components in a particular attitude, and if the particular attitude is changed, the directional indications change accordingly.

Furthermore, descriptions such as those involving “first” and “second” in the disclosure are for descriptive purposes only and are not to be construed as indicating or implying their relative importance or implicitly specifying the number of technical features indicated. Thus, the features defined with “first” and “second” may explicitly or implicitly include at least one such feature. In addition, the technical solutions of various described embodiments may be combined with each other, but only on the basis that those skilled in the art can realize. When a combination of technical solutions appears to be contradictory or unrealizable, such combination is regarded not to exist, and is not within the scope of protection of the disclosure.

The disclosure will be described in detail by referring to illustrated embodiments in combination with the attached drawings.

In one aspect of the disclosure, a micro-magnetic integrated orthodontic bracket is provided, and the problems of poor comfort, inconvenient operation, and low patient compliance of a device for accelerating the tooth movement can be solved by using one or more embodiments of the disclosure.

Orthodontic treatment in medical treatment is often referred to as orthodontics. The principle is to exert an appropriate external force to the teeth. The force will be transmitted to the alveolar bone around the teeth through the teeth, which will lead to reconstruction of the alveolar bone with active metabolism, and then drive the teeth to move slowly together.

Orthodontic bracket is an important component used in the orthodontic treatment, which is directly bonded to a surface of crown with adhesives, and an arch wire exerts various types of orthodontic force on the teeth through the orthodontic bracket. The arch wire is a metal wire stuck in the groove of the bracket or passed through the ring tube, also known as corrective arch wire, and is the most important device for the orthodontic force exertion. The orthodontic bracket is made of stainless steel, bioceramics or composite resin, and its main function is to fix the arch wire, so that the arch wire can play a better role in transmitting the orthodontic force, thereby to control three-dimensional movement of the teeth and to achieve the orthodontic treatment.

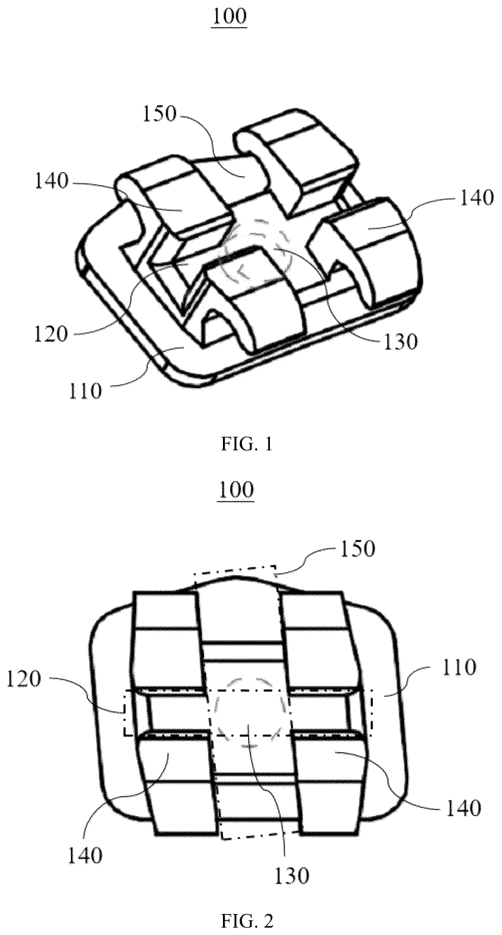

The micro-magnetic integrated orthodontic bracket provided by the disclosure first plays the role of a conventional orthodontic bracket, that is, it is used to fix the arch wire, thereby to provide the orthodontic force. Therefore, referring to FIGS. 1-2, the micro-magnetic integrated orthodontic bracket 100 according to the embodiment of the disclosure includes: a base body 110, an arch wire groove 120. The base body 110 is used to fix the micro-magnetic integrated orthodontic bracket 100 on a tooth. The base body 110 is designed to strengthen the bonding force with the tooth surface. The surface shape of the base body 110 of the micro-magnetic integrated orthodontic bracket 100 is consistent with the shape of the lip and cheek surfaces of each tooth. The base body 110 has metal mesh or an etched substrate, which makes the micro-magnetic integrated orthodontic bracket firmly bonded to the tooth surface through the adhesives. The arch wire groove 120 is located on the base body 110, and the arch wire groove 120 is used to pass through the arch wire and to exert force on the tooth.

In some embodiments, the micro-magnetic integrated orthodontic bracket 100 can be either a conventional bracket or a self-locking bracket. The conventional bracket and self-locking bracket have different advantages and disadvantages, but both are suitable for making the micro-magnetic integrated orthodontic bracket 100 of the disclosure.

In some embodiments, the conventional bracket needs to fix the arch wire with a help of a thin steel wire or a ligation ring, which is easy to cause damage to soft tissues, thereby to cause mouth ulcer. Furthermore, the ligation is easier to generate some artificial friction and the greater the friction, the longer the orthodontic treatment. Finally, the patient wearing the conventional bracket takes a long time to return to the hospital, and the return visit interval is about one month.

In some embodiments, the self-locking bracket is a buccal fixed bracket, which relies on sliding or rotating bracket cover, bolt cover or elastic clip to fix the arch wire in the bracket groove, without wearing the ligation wire, so it is more comfortable and safe to wear. In addition, the self-locking bracket can reduce the friction force during the orthodontic treatment, which can make the tooth move faster and reduce the duration of the orthodontic treatment. Finally, the return visit interval of the self-locking bracket can be extended to about two months for once adjustment in the hospital.

Compared with the conventional bracket, which is non-self-locking, the self-locking bracket can significantly reduce discomfort during the orthodontic treatment, extend the time between follow-up visits, shorten the time of oral operation, and make it easier to clean and maintain oral hygiene. In addition, the self-locking bracket can also reduce the resistance of tooth movement and help the teeth to be leveled and aligned faster. The double-clip self-locking bracket also has a special automatic protection function. When the orthodontic force is too large, it can automatically release the arch wire to avoid causing damage to the teeth and apical absorption, so that the teeth and periodontal heath are better protected. The self-locking bracket is also made of metal materials and ceramic materials, both of which have the above described features. The color of the ceramic self-locking bracket is very close to that of the teeth, which is more beautiful than the metal self-locking bracket.

In some embodiments, the metal bracket has the advantages of low friction, easy tooth movement, and the disadvantage is that the metal color is not beautiful.

In some embodiments, the ceramic bracket is popular with adults and patients with high aesthetic requirements because the color of ceramic materials is close to that of the teeth; therefore, it is good for concealment when sticking to the teeth, so that the ceramic materials have become one of the indispensable materials for the orthodontic treatment. However, the strength of the ceramic material is weak, and it is easy to break during the orthodontic treatment or removal process, affecting the treatment results. And the color is easy to be stained and discolored due to the poor oral hygiene maintenance habits of the patients. However, with the birth of a new generation of microcrystalline ceramic materials, under the premise of ensuring the overall strength, materials of high-end ceramic bracket today are smaller in size, higher in strength, and have the advantages of not easy to dye, discolor and easy to remove.

Referring to FIGS. 1-2, in some embodiments, the micro-magnetic integrated orthodontic bracket 100 provided by the disclosure further includes an accommodating cavity 130 disposed in the base body 110, and the accommodating cavity 130 is filled with a paramagnetic material. The paramagnetic material usually generates no magnetic field and needs to be stimulated by an external magnetic field. In an illustrated embodiment of the disclosure, the paramagnetic material can be activated under the action of a static magnetic field to generate a local micro-magnetic field. The paramagnetic material, for example, can be paramagnetic ferric oxide nanoparticles.

In some embodiments, the arch wire groove 120 is used to fix the arch wire. If the micro-magnetic integrated orthodontic bracket 100 is only used to be stimulated to generate the local micro-magnetic field and not used to fix the arch wire, the micro-magnetic integrated orthodontic bracket 100 can also exclude the arch wire groove 120.

In some embodiments, the micro-magnetic integrated orthodontic bracket 100 as a whole is made of the paramagnetic material, so that a structure of the micro-magnetic integrated orthodontic bracket is consistent with that of the existing orthodontic bracket, but the material therein is the paramagnetic material, which enables the micro-magnetic integrated orthodontic bracket 100 to stimulate the generation of the micro-magnetic field.

Due to magnetic field effect widely exists in nature and human tissues, the local magnetic field stimulation in physiological magnitude has been proved to regulate bone metabolism level, promote fracture healing and bone repair process. The mechanism study shows that the stimulation of the magnetic field can up-regulate expression levels of bone related proteins such as bone morphogenetic protein-2 (BMP2), BMP4, recombinant human notch 2 protein (NOTCH2) and osteocalcin (OCN), and activate mitogen-activated protein kinase (MAPK) and WNT/β-Catenin and other multiple signal pathways to promote the biological process of bone metabolism.

Compared with local physical vibration stimulation, ultrasonic stimulation and near-infrared stimulation, the local micro-magnetic field stimulation avoids the discomfort caused by mechanical stimulation to the patients, and avoids the potential burning injury caused by near-infrared photothermal effect to oral mucosa. It is bio-friendly, comfortable, and high patient compliance. Therefore, the local micro-magnetic field stimulation plays an important role in promoting alveolar bone metabolism and tooth movement in the orthodontic treatment.

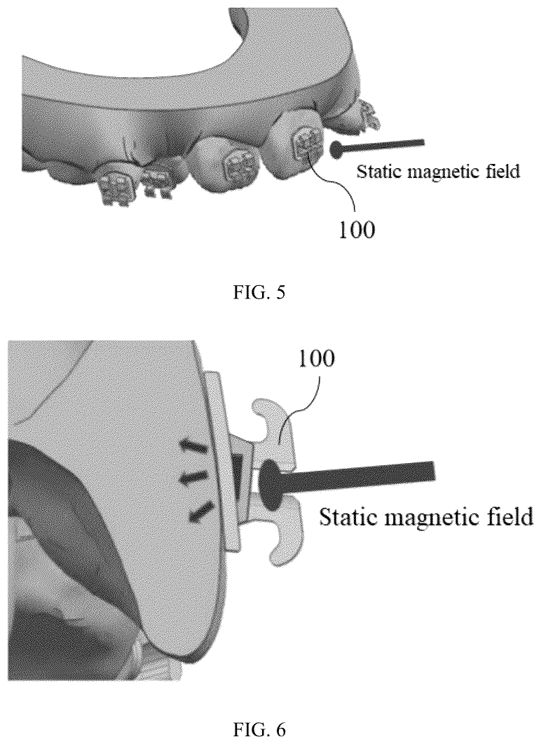

In some embodiments, when the tooth to be accelerated is needed to be stimulated by the local micro-magnetic field, an external static magnetic field is exerted locally to the micro-magnetic integrated orthodontic bracket 100, and an intensity of the external static magnetic field is 20 magnetic fluxes per unit area (mT). Referring to FIGS. 5-6, the external static magnetic field activates the paramagnetic material in the accommodating cavity 130 to generate the local micro-magnetic field with strength of 300 mT, which can accurately control and promote the orthodontic tooth movement and reconstruction of the alveolar bone.

In some embodiments, components of the micro-magnetic integrated orthodontic bracket 100 are used in the whole orthodontic treatment, and the components are light and small in size, and the base body 110 is close to the gingivae root and periodontal tissues of the tooth, which is convenient to precisely apply the local micro-magnetic field stimulation to the designated area. Integrating the concept of micro-magnetic field orthodontic acceleration into the conventional orthodontic treatment system can avoid using complex external acceleration devices.

In some embodiments, a preparation method of the micro-magnetic integrated orthodontic bracket 100 includes, for example, using computer numerical control (CNC) precision machining technology to prepare a groove structure in the base body of the metal orthodontic bracket; filling the paramagnetic ferric oxide nanoparticles into the groove; and sealing the groove surface to form the accommodating cavity. Under the condition of maintaining the stability of the overall mechanical performance of the bracket, it is endowed with paramagnetic characteristics, that is, the bracket does not generate the local micro-magnetic field under normal wear, and only when it is activated by the external magnetic field, it can generate the local micro-magnetic field, thus realizing the controllable activation of the bracket magnetic effect.

In some embodiments, the micro-magnetic integrated orthodontic bracket 100 retains the surface structure design of the conventional bracket, and the CNC preparation technology does not damage its strength, mechanical structure and function. The micro-magnetic integrated orthodontic bracket 100 can be normally placed on the buccal side of the tooth, and its front can be normally arranged with the arch wire for the orthodontic treatment. At the same time, the paramagnetic material at its base body 110 endows the micro-magnetic integrated orthodontic bracket 100 the function of generating the local micro-magnetic field.

In some embodiments, the micro-magnetic integrated orthodontic bracket 100 integrates the concept of orthodontic acceleration treatment with exerting the external field into the components of the conventional orthodontic treatment for a first time, eliminating the help of additional devices during the orthodontic treatment, which is inconvenient. The micro-magnetic integrated orthodontic bracket 100 is adjustable, that is, it can normally be used for the orthodontic treatment without exerting the external magnetic field to generate the local micro-magnetic field. When the micro-magnetic integrated orthodontic bracket 100 is activated by the static magnetic field, the micro-magnetic field required can be accurately generated in the part of the tooth to be moved, thus promoting the alveolar bone metabolism and tooth movement.

The orthodontic treatment involves multiple links and processes of the overall remodeling of the teeth and jaws. According to the treatment strategy, the teeth that need to be moved are constantly adjusted at different stages. In some embodiments, the micro-magnetic integrated orthodontic bracket 100 of the disclosure is able to be used at different treatment stages, and it takes advantages of the static magnetic field to activate the bracket in corresponding areas, thereby to achieve accurate and adjustable personalized local micro-magnetic field tooth movement acceleration treatment.

For the same orthodontic moving tooth, in an early stage of the orthodontic treatment, the osteoclasis of alveolar bone is more important than osteogenesis, which provides potential power for tooth movement. In the later stage of the orthodontic treatment, the osteogenesis of alveolar bone is more important than osteoclasis to maintain the stability of the moving tooth. Therefore, an intensity of the micro-magnetic field stimulation applied locally should be adjusted according to the corresponding physiological process. In some embodiments, the micro-magnetic integrated orthodontic bracket 100 of the disclosure can adjust and control the intensity of the micro-magnetic field stimulation by adjusting the size of the exerted static magnetic field, which is suitable for the differential requirements of the micro-magnetic field at different stages of the teeth to be moved.

In some embodiments, referring to FIGS. 1-2, the micro-magnetic integrated orthodontic bracket 100 further includes protruding portions 140 (i.e. at least two protruding portions 140), the protruding portions 140 are disposed on the base body 110, and the arch wire groove 120 is located between the protruding portions 140. The protruding portions 140 are wings of the bracket, which are convenient for binding and fixing the arch wire. Each of the wings can be attached with a hook for traction. According to the shape of the wing of the bracket, the wing is divided into a single-wing type, a double-wing type and a triple-wing type. The two protruding portions 140 are single-wing, and the four protruding portions 140 are double-wing.

In some embodiments, the number of the protruding portions 140 is four, and the four protruding portions 140 cooperatively define a rectangle. The four protruding portions 140 define the arch wire groove 120 in an arranged direction of the arch wire, and define a position-limiting groove 150 in a direction perpendicular to the arranged direction of the arch wire. The position-limiting groove 150 can be used to fix the exerted static magnetic field, making it more convenient to use.

In some embodiments, referring to FIGS. 1-2, the accommodating cavity 130 is located between the protruding portions 140. There are many gaps between the protruding portions 140 to facilitate the preparation of the accommodating cavity 130, and the arch wire groove 120 is located between the protruding portions 140. Therefore, the arch wire and the micro-magnetic field act in the same place and play a synergistic role.

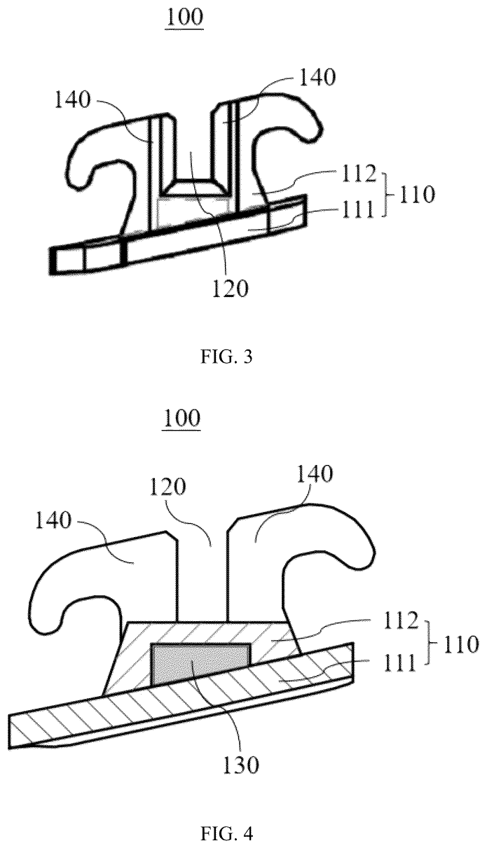

In some embodiments, referring to FIGS. 3-4, the base body 110 of the micro-magnetic integrated orthodontic bracket 100 includes: a substrate 111 and a boss 112, and the substrate 111 is used to fix the micro-magnetic integrated orthodontic bracket 100 on the tooth. The boss 112 is disposed on the substrate 111, and the protruding portions 140 and the accommodating cavity 130 are located on the boss 112.

In some embodiments, the micro-magnetic integrated orthodontic bracket 100 of the disclosure needs to be equipped with the accommodating cavity 130 filled with the paramagnetic material, so that the base body 110 of the disclosure needs to have a certain thickness to prepare the accommodating cavity 130 to fill with the paramagnetic material. By setting the base body 110 with the substrate 111 and the boss 112, and setting the accommodating cavity 130 on the boss 112, thereby the thickness of the substrate 111 can be consistent with that of the conventional orthodontic bracket, and it is not necessary to thicken the components on the base body, thus saving costs.

In some embodiments, the micro-magnetic integrated orthodontic bracket 100 provided by the disclosure includes the base body 110 and the arch wire groove 120 disposed on the base body 110. The arch wire groove 120 is used to pass through the arch wire. Under normal orthodontic conditions, the micro-magnetic integrated orthodontic bracket 100 can be normally placed on the buccal side of the tooth, and its front side can be normally arranged with the arch wire after the orthodontic force exertion, and the micro-magnetic integrated orthodontic bracket 100 is used as a carrier to bear the orthodontic force generated by the arch wire. The micro-magnetic integrated orthodontic bracket 100 further includes the accommodating cavity 130 disposed in the base body 110, and the accommodating cavity 130 is filled with the paramagnetic material. When the local micro-magnetic field is required to stimulate the tooth to be accelerated during the orthodontic treatment, the local micro-magnetic field stimulation is generated by exerting the static magnetic field to the accommodating cavity 130 of the micro-magnetic integrated orthodontic bracket 100 to activate the paramagnetic material, thereby to accurately control and promote the orthodontic tooth movement and the reconstruction of alveolar bone. The micro-magnetic integrated orthodontic bracket 100 does not need to be equipped with an additional device to accelerate the tooth movement, but only needs to be improved on the basis of the orthodontic bracket and filling the paramagnetic material to obtain a device that can accelerate the tooth movement, with simple structure, simple preparation method, low cost and high patient compliance.

In some embodiments, the disclosure also provides a flexible magnetic patch 200, which includes a sheet silicone matrix and permanent magnetic powders dispersed into the sheet silicone matrix. The permanent magnetic powders exist in the static magnetic field stably for a long time, and the permanent magnetic powders can be NdFeB (Neodymium-Iron-Boron) magnetic powders. The flexible magnetic patch is used as the static magnetic field to excite the paramagnetic material of the micro-magnetic integrated orthodontic bracket 100 to generate the local micro-magnetic field. According to the feature of excitation magnetic field generated by the paramagnetic material, the magnetic field intensity generated by the paramagnetic material of the micro-magnetic integrated orthodontic bracket 100 can be adjusted by adjusting the content of the permanent magnetic powders in the flexible magnetic patch 200. The flexible magnetic patch 200 can be fixed in the position-limiting groove 150 of the micro-magnetic integrated orthodontic bracket 100, which is convenient for use.

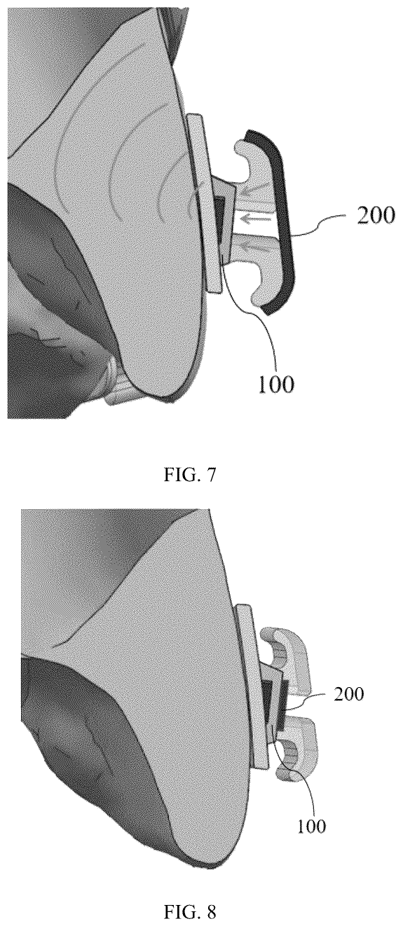

In some embodiments, when the flexible magnetic patch 200 is used, referring to FIGS. 7-8, the micro-magnetic integrated orthodontic bracket 100 is first attached to the patient's teeth to be treated with the fixed orthodontic treatment, and the orthodontic force is exerted to the arch wire. For the area where the micro-magnetic field stimulation is needed to accelerate reconstruction of periodontal bone, the corresponding flexible magnetic patch 200 is attached to the micro-magnetic integrated orthodontic bracket 100 on the corresponding tooth, and the flexible magnetic patch 200 is malleable and can fit completely on the surface of the micro-magnetic integrated orthodontic bracket 100, followed by activating the paramagnetic material inside, thus generating the local micro-magnetic field stimulation to promote local reconstruction of the alveolar bone and tooth movement. The micro-magnetic integrated orthodontic bracket 100 does not generate the local micro-magnetic field without activating the flexible magnetic patch 200, thereby to only be used as the conventional bracket. When the flexible magnetic patch 200 is activated, the micro-magnetic integrated orthodontic bracket 100 can accurately generate the required micro-magnetic field in the local area of the tooth to be moved, thus promoting alveolar bone metabolism and tooth movement.

In some embodiments, a volume of the flexible magnetic patch 200 is in a range of greater than 0 cubic millimeters (mm³) and less than or equal to 2.4 mm³. In an illustrated embodiment of the disclosure, the volume of the flexible magnetic patch 200 is in a range of greater than or equal to 0.5 mm³ and less than and equal to 1.5 mm³, or in a range of greater than or equal to 0.8 mm³ and less than and equal to 2.0 mm³, or in a range of greater than or equal to 1.0 mm³ and less than and equal to 2.4 mm³.

The disclosure also provides a preparation method of the flexible magnetic patch 200 described above, which includes: preparing permanent magnetic powders; and breaking an NdFeB permanent magnet to prepare NdFeB magnetic powders to make the magnetic material have good plasticity and ductility. In another way, a finished soft magnetic sheet is cut to prepare the magnetic powders with personalized size and shape.

The permanent magnetic powders are mixed with a silicone to prepare the flexible magnetic patch 200. The permanent magnetic powders are dispersed into the ultra-thin silicone with good biocompatibility, safety, non-toxicity and excellent plasticity. The silicone has the characteristics of flexibility, plasticity and stickiness. According to the size and local exertion range of the micro-magnetic integrated orthodontic bracket 100, the corresponding shape of the flexible magnetic patch 200 is designed, and it is prepared to activate the micro-magnetic integrated orthodontic bracket 100 to generate the local micro-magnetic field.

The disclosure also provides a method for accelerating tooth movement, which includes: fixing the above-mentioned micro-magnetic integrated orthodontic bracket 100 on the buccal side of the tooth; placing the flexible magnetic patch 200 around the accommodating cavity 130 to excite the paramagnetic material inside, thereby to generate the local micro-magnetic field, which acts on the periodontal tissues.

When the micro-magnetic integrated orthodontic bracket 100 is activated by the flexible magnetic patch 200, it can accurately generate the required local micro-magnetic field for the tooth to be moved, thus promoting the alveolar bone metabolism and tooth movement. And the flexible magnetic patch 200 can activate the micro-magnetic integrated orthodontic bracket 100 in the corresponding area at different treatment stages, thereby to achieve accurate and adjustable personalized tooth movement acceleration treatment under the action of the local micro-magnetic field. The intensity of the local micro-magnetic field can also be adjusted by adjusting the dosage of the permanent magnetic powders in the prepared flexible magnetic patch 200 to adapt to the differential requirements of the micro-magnetic field at different stages of the teeth to be moved.

In the description of the disclosure, it needs to be understood that the terms “center”, “longitudinal”, “transverse”, “length”, “width”, “thickness”, “up”, “down”, “front”, “back”, “left”, “right”, “vertical”, “horizontal”, “top”, “bottom”, “inside”, “outside, “clockwise”, “counterclockwise”, and the like indicate orientation or positional relationships, which are based on the attached drawings. In addition, the terms are intended only to facilitate the description of the disclosure and simplify the description, and are not intended to indicate or imply that the devices or components referred to must have a particular orientation, be constructed and operated in a particular orientation. Therefore, the terms cannot be understood as limiting the disclosure.

In the description of the disclosure, unless otherwise expressly specified and limited, the first feature “on” or “under” the second feature may include a direct contact between the first feature and the second feature, or may include that the first feature and the second feature are not in contact directly, but through another features between them. Also, the first feature being “on”, “upper” and “above” the second feature includes the first feature being directly above and diagonally above the second feature, or simply indicating that the first feature is horizontally higher above the second feature. The first feature being “under”, “lower” and “below” the second feature includes the first feature being directly below and diagonally below the second feature, or simply indicating that the first feature is less than the horizontal height of the second feature.

In the description of the specification, reference to the terms “an embodiment”, “some embodiments”, “example”, “the illustrated embodiment”, or “some examples”, the above descriptions mean that the specific features, structures, materials, or characteristics described in connection with the embodiment or example are included in at least one embodiment or example of the disclosure. In the specification, the schematic representation of the above terms need not be directed to the same embodiment or example. Moreover, the specific features, structures, materials, or characteristics described may be combined in a suitable manner in any one or more embodiments or examples. In addition, those skilled in the related art may join and combine the different embodiments or examples described in the specification.

Although the illustrated embodiments of the disclosure have been described, those skilled in the related art can make additional changes and modifications to these embodiments based on basic concepts. Therefore, the appended claims are intended to be construed to include the illustrated embodiments and all changes and modifications that fall within the scope of the disclosure.

It is clear that those skilled in the related art can make various modifications and variations to the disclosure without departing from the spirit and scope of the disclosure. Therefore, if the various modifications and variations of the disclosure fall within the scope of the claims of the disclosure and their technical equivalents, the disclosure is also intended to encompass such modifications and variations.

What is claimed is:

1. A micro-magnetic integrated orthodontic bracket, comprising:
a base body, configured to fix the micro-magnetic integrated orthodontic bracket on a tooth;
wherein an accommodating cavity is disposed in the base body and filled with a paramagnetic material or the micro-magnetic integrated orthodontic bracket as a whole is made of the paramagnetic material.

2. The micro-magnetic integrated orthodontic bracket according to claim 1, further comprising:
an arch wire groove, wherein the arch wire groove is located on the base body.

3. The micro-magnetic integrated orthodontic bracket according to claim 2, further comprising:
protruding portions, wherein a number of the protruding portions is at least two, the at least two protruding portions are disposed on the base body, and the arch wire groove is located between the at least two protruding portions.

4. The micro-magnetic integrated orthodontic bracket according to claim 3, wherein the accommodating cavity is disposed between the at least two protruding portions.

5. The micro-magnetic integrated orthodontic bracket according to claim 3, wherein the base body comprises:
a substrate, configured to fix the micro-magnetic integrated orthodontic bracket on the tooth; and
a boss, disposed on the substrate, wherein the at least two protruding portions and the accommodating cavity are disposed on the boss.

6. The micro-magnetic integrated orthodontic bracket according to claim 3, wherein the number of the protruding portions is four, the four protruding portions cooperatively define a rectangle, the four protruding portions define the arch wire groove in an arrangement direction of an arch wire and further define a position-limiting groove in a direction perpendicular to the arrangement direction of the arch wire.

7. A flexible magnetic patch, comprising:
a sheet silicone matrix; and
permanent magnetic powders, dispersed into the sheet silicone matrix.

8. The flexible magnetic patch according to claim 7, wherein a volume of the flexible magnetic patch is in a range of greater than 0 cubic millimeter (mm³) and less than or equal to 2.4 mm³.

9. A preparation method of the flexible magnetic patch according to claim 7, comprising:
preparing the permanent magnetic powders; and
mixing the permanent magnetic powders with a silicone thereby to prepare the flexible magnetic patch.

10. A method for accelerating tooth movement, comprising:
fixing the micro-magnetic integrated orthodontic bracket according to claim 1 to a buccal side of a tooth; and
placing the flexible magnetic patch according to claim 7 around the accommodating cavity thereby to excite the paramagnetic material to generate a controlled local micro-magnetic field that acts on periodontal tissues to promote metabolism and reconstruction of soft and hard tissues.
